(19) United States
(12) Patent Application Publication
(10) Pub. No.: US 2011/0174135 A1
(43) Pub. Date: Jul. 21, 2011

(54) SUPPORTING SEAT OF A PICKUP DEVICE FOR A DRUM CYLINDER

(76) Inventor: CHAO-YING HSIEN, Kaohsiung City (TW)

(21) Appl. No.: 12/690,937

(22) Filed: Jan. 21, 2010

(51) Int. Cl. G10D 13/02

(52) U.S. Cl. 84/411 P

(57) ABSTRACT

A supporting seat of a pickup device for a drum cylinder comprises a supporting seat having a supporting portion and a positioning portion at one end of the supporting portion; a positioning portion having a hook shape and an outer side of the positioning portion being installed with a signal output terminal seat; and a pickup device installed to the supporting portion of the supporting seat; the pickup device being enclosed by foam or other soft material. A wireless signal transceiver is attached to the supporting seat and the supporting seat is connected to the pickup device. A battery seat has at least one battery therein and is added to an outer side of the positioning portion of the supporting seat; and the battery seat supplies electric power to the wireless signal transceiver.

### FIELD OF THE INVENTION

The present invention relates to drum, in particular to a supporting seat of a pickup device of a drum.

### BACKGROUND OF THE INVENTION

As we know jazz tomtoms are popular musical instrument, however, the great sounds from jazz tomtom will influent other people nearby, especially, in an area living with many people. Although sound isolation chamber can resolve this problem, no every people can support this way because the sound isolation chamber is very expensive. To solve this problem, sound canceling drum is develop, in that the drum surface is replaced by a net body instead of polyester film which is used in the prior art. Thereby, users can beat the drum with less sound so as not to affect the environment.

However such kind of jazz tomtom cannot emit the sound as the conventional jazz tomtom so that the drum beater can not have the same sound feeling as beating a conventional jazz tomtom. Thus, a method for resolving such problem is that a pickup device is used to contact the drum surface. The beating signal is picked up and then is transferred to a sound module so as to emit a correct drum beating sound, but this way has a problem to be resolved, that is, the pickup device may correctly contact the drum surface.

### SUMMARY OF THE INVENTION

Accordingly, the object of the present invention is to provide a supporting seat of a pickup device for a drum cylinder, wherein the pickup device can contact the drum beating surface so as to have a preferred beating signals.

To achieve above object, the present invention provides a supporting seat of a pickup device for a drum cylinder, comprising; a supporting seat having a supporting portion and a positioning portion at one end of the supporting portion; a positioning portion having a hook shape and an outer side of the positioning portion being installed with a signal output terminal seat; and a pickup device installed to the supporting portion of the supporting seat; the pickup device being enclosed by foam or other soft material.

Furthermore, a wireless signal transceiver is attached to the supporting seat and the supporting seat is connected to the pickup device. A battery seat has at least one battery therein and is added to an outer side of the positioning portion of the supporting seat; the battery seat supplies electric power to the wireless signal transceiver. The positioning portion is installed with a pad at a position corresponding to that of the cylinder of the drum. The positioning portion is positioned uprightly. The pickup device is connected to the wireless signal transceiver through a signal wire.

The various objects and advantages of the present invention will be more readily understood from the following detailed description when read in conjunction with the appended drawing.

### BRIEF DESCRIPTION OF THE DRAWINGS

FIG. 1 is a structural schematic view of the preferred embodiment of the present invention.

FIG. 2 is a schematic view about the installation of the preferred embodiment of the present invention.

FIG. 3 is a cross sectional view of the structure in FIG. 2.

FIG. 4 shows an application about the preferred embodiment of the present invention, where wired connection is used.

FIG. 5 shows an application about the preferred embodiment of the present invention, where wireless connection is used.

FIG. 6 is a schematic view showing the structure of the second embodiment of the present invention.

FIG. 7 is a schematic view showing that the present invention is installed to a drum in the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

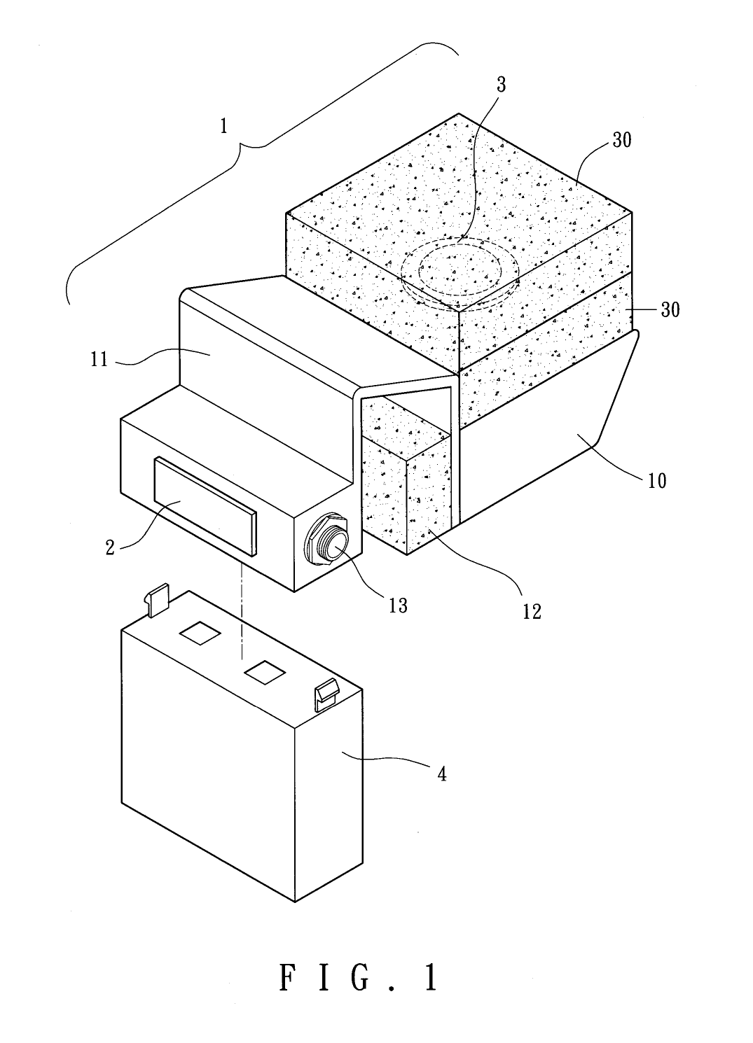

Referring to FIG. 1, the structure of the present invention is illustrated. The present invention has the following elements.

A supporting seat 1 has a supporting portion 10 and a positioning portion 11 at one end of the supporting portion 10.

The positioning portion 11 has a hook shape and an outer side of the positioning portion 11 is installed with a signal output terminal seat 13.

A wireless signal transceiver 2 is attached to the supporting seat 1.

A pickup device 3 is installed to the supporting portion 10 of the supporting seat 1. The pickup device 3 is enclosed by foam or other soft material. The pickup device 3 is connected to the wireless signal transceiver 2.

A battery seat 4 has at least one battery therein and is added to an outer side of the positioning portion 11 of the supporting seat 1. The battery seat 4 supplies electric power to the wireless signal transceiver 2.

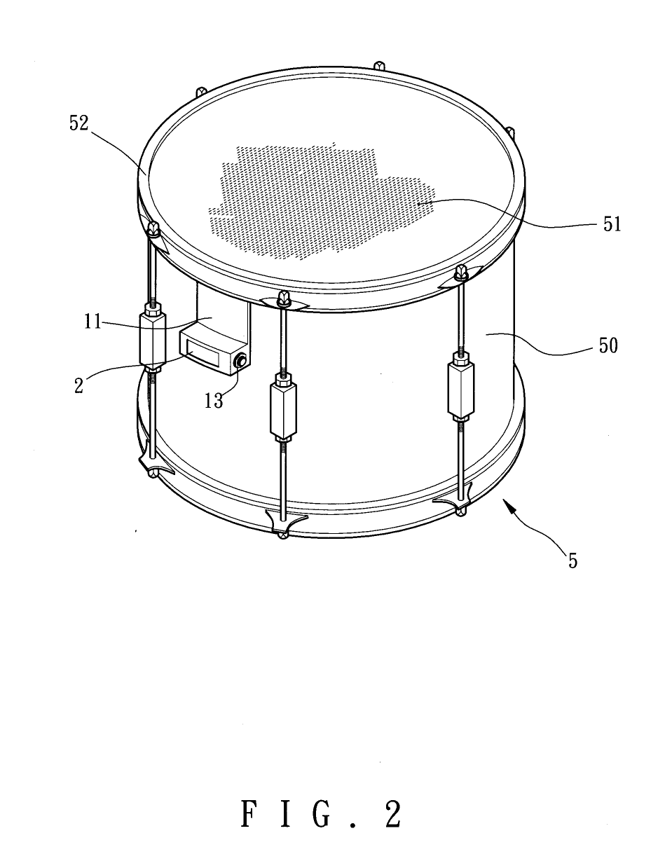

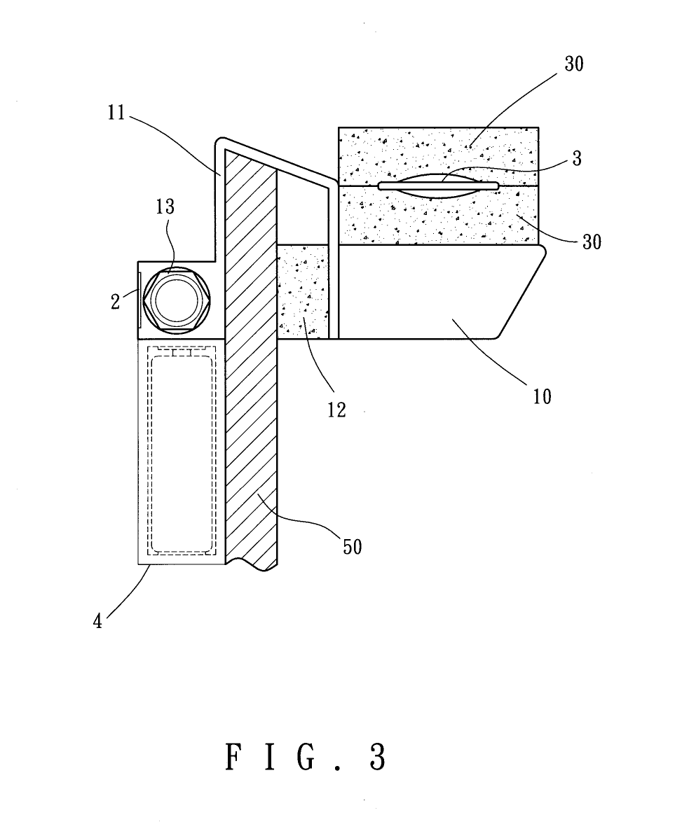

Referring to FIGS. 2 and 3, it is illustrated that the device of the present invention is installed to a drum cylinder 50 of a drum 5. The positioning portion 11 is hooked to the cylinder 50 and then is combined with the drum upper surface 51. Then a retaining frame 52 will lock the positioning portion 11 to the drum 5. A pad 12 is installed at a hooked interior of the positioning portion 11 near the cylinder 50 of the drum 5. The pickup device 3 of the supporting portion 10 is adjusted to have a preferred contact with the drum upper surface 51 so as to provide a buffer function which is helpful to have a preferred signal to the pickup device 3.

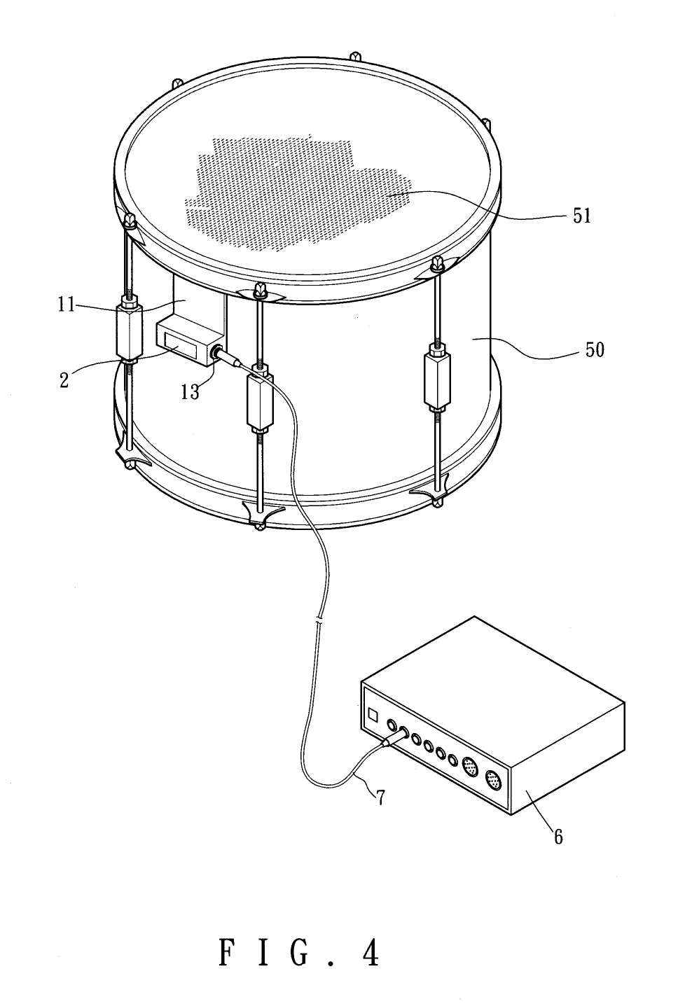

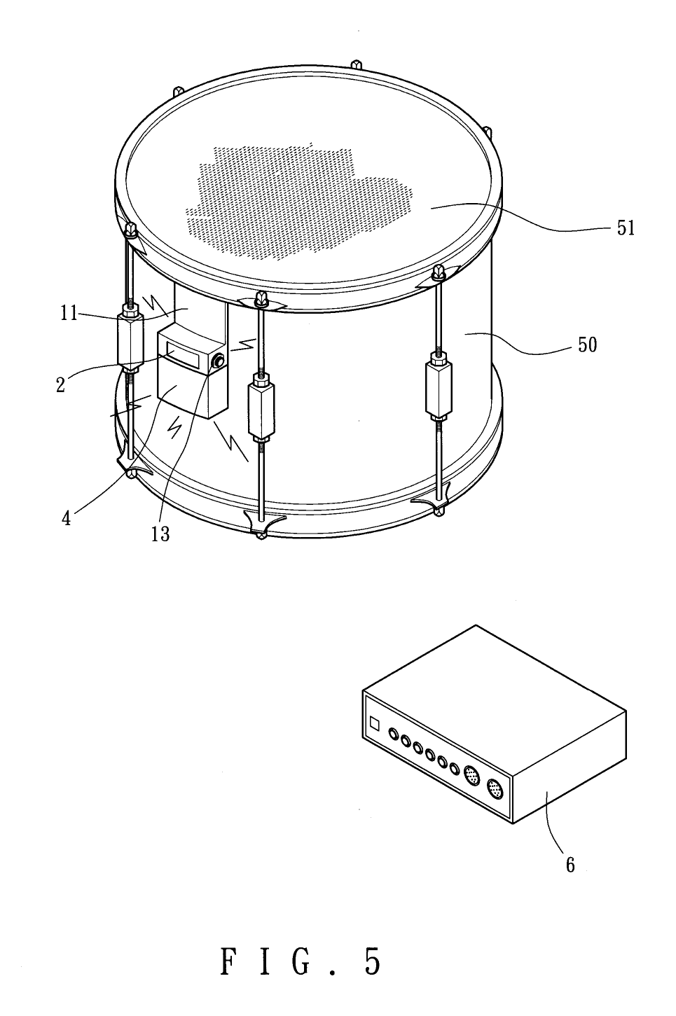

Referring to FIG. 4, a signal wire 7 serves to connect the signal output terminal seat 13 to a sound module 6. After combining with the battery seat 4, the wireless signal transceiver 2 will be actuated and is connected to the sound module 6 wirelessly. This effect is especially suitable for a performance. No wire is needed and it is unnecessary to wire, as illustrated in FIG. 5.

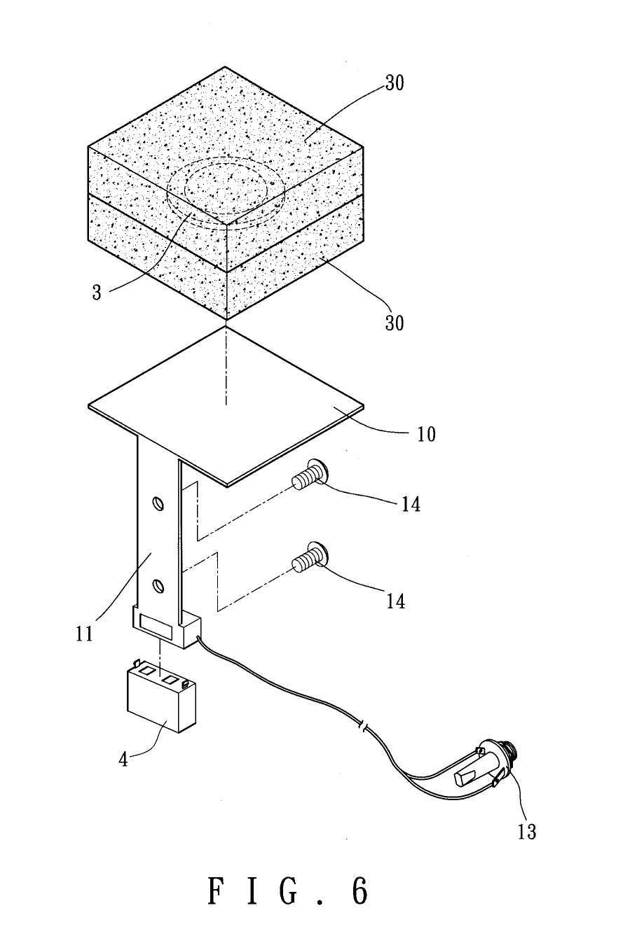

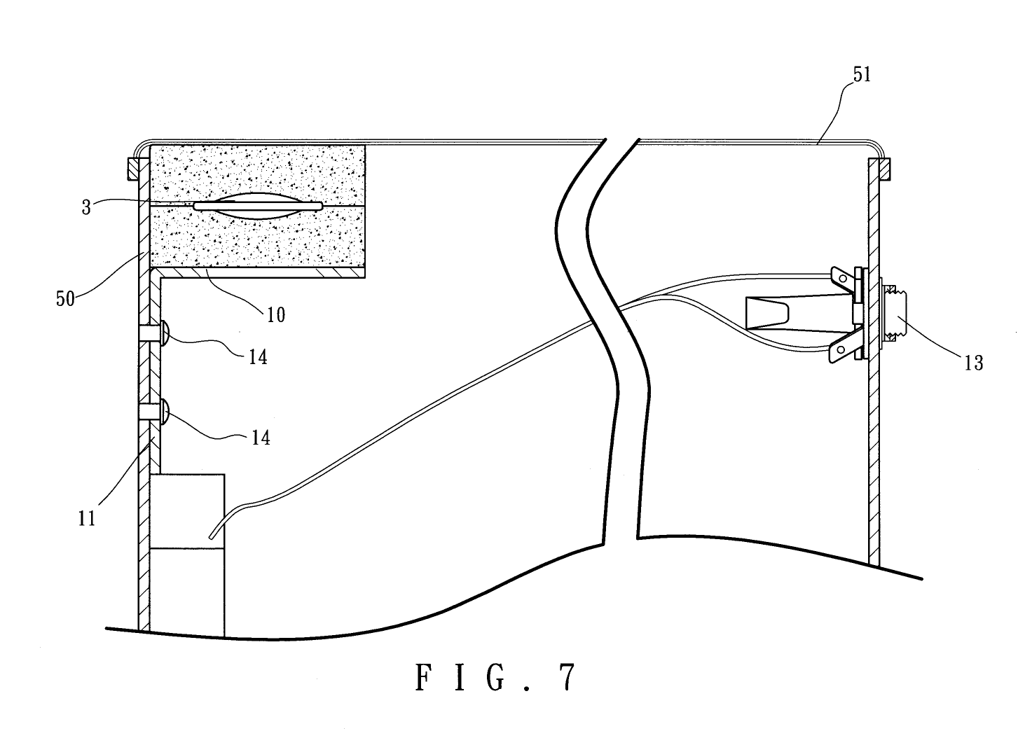

With reference to FIGS. 6 and 7, a schematic view showing another embodiment of the present invention. The positioning portion 11 may be a stand object. The pickup device 3 is connected to the signal output terminal seat 13 the wireless signal transceiver 2 by wires. Thus, the positioning portion 11 is directly screwed to an interior of the cylinder 50 or connected to the interior of the cylinder 50 by other ways. The signal output terminal seat 13 is retained to a predetermined position of the cylinder 50. This is another embodiment of the present invention.

Similarly, the supporting seat 1 is installed with a wireless signal transceiver 2 which has a power supply from the battery seat 4, while the wireless signal transceiver 2 is wirelessly connected to the sound module 6.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A supporting seat of a pickup device for a drum cylinder, comprising;
a supporting seat having a supporting portion and a positioning portion at one end of the supporting portion;
a positioning portion having a hook shape and an outer side of the positioning portion being installed with a signal output terminal seat; and
a pickup device installed to the supporting portion of the supporting seat; the pickup device being enclosed by foam or other soft material.

2. The supporting seat of a pickup device for a drum cylinder as claimed in claim 1, wherein a wireless signal transceiver is attached to the supporting seat and the supporting seat is connected to the pickup device.

3. The supporting seat of a pickup device for a drum cylinder as claimed in claim 1, wherein a battery seat has at least one battery therein and is added to an outer side of the positioning portion of the supporting seat; and the battery seat supplies electric power to the wireless signal transceiver.

4. The supporting seat of a pickup device for a drum cylinder as claimed in claim 1, wherein the positioning portion is installed with a pad at a position corresponding to that of the cylinder of the drum.

5. The supporting seat of a pickup device for a drum cylinder as claimed in claim 1, wherein the positioning portion is positioned uprightly.

6. The supporting seat of a pickup device for a drum cylinder as claimed in claim 1, wherein the pickup device is connected to the wireless signal transceiver through a signal wire.
